(19) United States
(12) Patent Application Publication
(10) Pub. No.: US 2024/0155967 A1
(43) Pub. Date: May 16, 2024

(54) APPLICATION UNIT FOR AN AGRICULTURAL APPLICATION MACHINE

(71) Applicant: AMAZONEN-WERKE H. DREYER SE & CO. KG, Hasbergen (DE)

(72) Inventors: Roland ARNOLD, Ganderkesee (DE); Fabian DERTENKOETTER, Ostbevern (DE); Florenz HILBERT, Emsdetten (DE); Stefan Jan JOHANNABER, Lienen (DE); Jan Philipp RADEKE, Bassum (DE); Stephan TECKEMEYER, Lotte (DE); Thomas WIEN, Stuhr (DE)

(21) Appl. No.: 18/284,638

(22) PCT Filed: Mar. 2, 2022
(86) PCT No.: PCT/EP2022/055237

§ 371 Date: Sep. 28, 2023

(30) Foreign Application Priority Data
Mar. 31, 2021 (DE) 102021108172.6

(51) Int. Cl. A01C 7/08; A01C 7/20

(52) U.S. Cl. CPC A01C 7/081; A01C 7/20

(57) ABSTRACT

The invention relates to an application unit (10) for an agricultural application machine for applying granular material to an agriculturally used area (N), comprising a granular material portioning device (12) into which a granular material flow conveying bulk granular material can be introduced and by means of which portions (P) of granular material can be created from the granular material flow, the application unit (10) being equipped with an air separator (30) that allows air to be separated from the granular material flow.

The invention relates to an application unit for an agricultural application machine according to the preamble of claim 1, and a method for applying granular material onto an agriculturally used area according to the preamble of claim 14.

In the management of agricultural areas, it is regularly necessary for granular material, for example fertilizers, to be applied to the agriculturally used area. A nutrient supply that is optimal in terms of crop production can be achieved in a plurality of applications in that the fertilizer is applied discontinuously onto the agriculturally used area, in the form of fertilizer portions. In order to create such portions of granular material, application units of agricultural application machines can be equipped with granular material portioning devices which combine the granular material grains of a continuous granular material flow into portions of granular material.

In practice, however, there is the problem that the granular material cannot be precisely portioned due to an unsuitable, frequently too high, amount of air in the granular material flow reaching the granular material portioning device. In addition, application situations exist in which it is desirable to temporarily and/or locally interrupt the portioned application of the granular material and to implement a conventional band application. However, switching from a portioned application of the granular material to a band application also requires an adjustment of the amount of air in the granular material flow and for this reason, is hitherto not implementable in practice.

The object on which the invention is based is thus to be able to adjust the amount of air to a granular material flow fed to a granular material portioning device.

The object is achieved by an application unit of the type mentioned at the outset, the application unit according to the invention comprising an air separator by means of which air can be separated from the granular material flow.

By means of the air separator, the air quantity of the granular material flow from which portions of granular material are to be created in an operating mode of an application unit can be adjusted. In this case, a portion of the air from the granular material flow can be separated by means of the air separator, for example. Alternatively, substantially all of the air can be separated from the granular material flow. The granular material can be fertilizer, for example, so that air can be separated from a fertilizer flow by means of the air separator. The granular material portioning device can consequently be, for example, a fertilizer portioning device which is designed to create fertilizer portions.

The air separator can be a centrifugal separator or a cyclone. The air separator preferably has a coil. The excess air is discharged from the air separator via an air outlet, preferably into the surroundings.

In a preferred embodiment of the application unit according to the invention, the air separator is arranged upstream of the granular material portioning device, in the flow direction of the granular material flow. The air separator can be placed or attached directly onto the granular material portioning device. In this case, air is separated from the granular material flow upstream of the granular material portioning device, by means of the air separator, i.e., before said flow is introduced into the granular material portioning device. The air separator is preferably a component of a granular material guide system, by means of which the granular material flow that conveys bulk granular material can be introduced into a portioning region of the granular material portioning device. By means of the granular material guide system, portions of granular material created by the granular material portioning device can preferably also be guided in the direction of the agriculturally used area.

In a further embodiment of the application unit according to the invention, the air separator is a component of the granular material portioning device. In this case, air is separated from the granular material flow, by means of the air separator, in the granular material portioning device. The air is thus initially introduced into the granular material portioning device.

Preferably, the separation behavior of the air separator is adjustable. The quantity or the portion of the air to be separated from the granular material flow can be adjusted via the adjustment of the separation behavior. By adjusting the separation behavior, for example the flow rate of the granular material flow can be adjusted. If a granular material flow conveying bulk granular material is to be passed through the granular material portioning device without creation of portions, pneumatic conveying of the granular material through the granular material portioning device can be achieved by adjusting the separation behavior. Furthermore, a specific flow rate or a minimum flow rate can be set, which may be necessary so that the application of a continuous granular material band is possible despite the passage of the granular material flow through the granular material portioning device.

The application unit according to the invention is further advantageously developed in that the air separator can be operated in a separation mode, in which air is separated out of the granular material flow, and a through-flow mode, in which no or at least a smaller amount of air is separated from the granular material flow than in the separation mode. In the through-flow mode, the air outlet of the air separator can be closed completely or in part, for example by means of a separation adjusting member, so that the entirety of the air or at least a portion of the air of the granular material flow is available for the conveyance of the granular material through the granular material portioning device.

In another preferred embodiment of the application unit according to the invention, the separation behavior of the air separator can be manually adjusted. Alternatively or additionally, the air separator can be switched manually between the separation mode and the through-flow mode.

Furthermore, an application unit according to the invention is preferred in which the air separator has a controllable actuator, by means of which the separation behavior of the air separator can be adjusted. Alternatively or additionally, the air separator is switchable between the separation mode and the through-flow mode by means of the controllable actuator. The actuator can be connected to a control device of the application unit or of the agricultural application machine, so that an automatic switchover between the separation mode and the through-flow mode can also take place within the scope of an application operation without any intervention by the machine operator being required. The separation behavior of air separators of a plurality of application units can be adjustable by means of the actuator.

In a development of the application unit according to the invention, the air separator has a movable separation adjusting member, via the position and/or orientation of which the separation behavior of the air separator can be adjusted and/or via the position and/or orientation of which the air separator can be switched between the separation mode and the through-flow mode. The separation adjusting member can be an adjustment slide, an adjustment flap or an adjustment cap, which can be moved manually, in particular displaced, rotated and/or pivoted, in order to adjust the separation behavior. For example, the adjustment cap can be screwed into a housing portion of the air separator, in particular into an air outlet of the air separator, in order to adjust the separation behavior, and can be rotated out of the housing portion of the air separator, in particular out of the air outlet of the air separator, a free flow cross section, in particular of the air outlet, being adjustable via the rotational position of the adjustment cap. The separation adjusting member can be actuatable manually and/or by means of a controllable actuator.

In one development, the application unit according to the invention is operable in a portion application mode in which the granular material is applied discontinuously onto the agriculturally used area, in the form of portions of granular material created by the granular material portioning device, and in a belt application mode, in which the granular material is applied continuously onto the agriculturally used area, in the form of a granular material band. In this case, the application unit can thus be used both for the portioned application of the granular material and for the conventional band application of the granular material. Granular material in the case of which the portion creation is problematic, not possible or is not desired, can therefore also be applied using the application unit in a conventional manner, as a continuous granular material belt. The granular material can be fertilizer, for example. In the portion application mode, fertilizer is thus applied discontinuously in the form of fertilizer portions. In this case, fertilizer is applied continuously onto the agriculturally used area in the form of a fertilizer band in the band application mode.

Preferably, a control device of the application unit is designed to operate the air separator in the separation mode when the application unit is operated in the portion application mode. Preferably, the control device of the application unit is designed to operate the air separator in the through-flow mode when the application unit is operated in the band application mode.

In another embodiment of the application unit according to the invention, the granular material portioning device comprises a portioning rotor arranged in the portioning region, which is rotatably drivable by means of a rotor drive of the granular material portioning device and is designed to combine granular material grains located in the portioning region into a portion of granular material, in the portion application mode, by means of a rotational movement. A control device of the application unit is preferably designed to control the rotor drive of the portioning rotor in the band application mode in such a way that the portioning rotor has a rotational speed which corresponds to the flow rate of the granular material flow, so that the granular material grains located in the portioning region are not combined to form a portion of granular material. The portioning rotor preferably has one or more drivers, via which the granular material grains are combined in the portion application mode. The one or more drivers of the portioning rotor support the conveying of the granular material flow through the granular material portioning device or through the portioning region of the granular material portioning device, in the band application mode, without portions of granular material being created.

Alternatively, the control device of the application unit can be designed to control the rotor drive of the portioning rotor, in the band application mode, in such a way that the portioning rotor is stationary, so that a granular material flow conveying bulk granular material is conducted through the granular material portioning device without portions being created. Alternatively, the control device of the application unit can be designed to control the rotor drive of the portioning rotor, in the band application mode, in such a way that the portioning rotor has a rotational speed which is so high that, despite combining of granular material grains located in the portioning region, a continuous granular material band is applied.

In an alternative embodiment of the application unit according to the invention, the granular material portioning device comprises a valve arranged in the portioning region, which valve is designed, in the portion application mode, to combine granular material grains, located in the portioning region, to form a portion of granular material. A control device of the application unit is preferably designed to control the opening and/or closing times of the valve in such a way that the granular material grains located in the portioning region are not combined in the band application mode.

In a development of the application unit according to the invention, the granular material portioning device is designed to be operated without a portioning rotor, in the band application mode. Alternatively, the granular material portioning device is designed to be operated, in the band application mode, with a portioning rotor that is modified in comparison to the portion application mode. The portioning rotor or parts of the portioning rotor can therefore be able to be dismantled, so that a granular material flow conveying bulk granular material is conducted through the granular material portioning device without creating portions. The portioning region and/or the granular material guide system can be designed such that the granular material flow is conducted directly through the portioning chamber or guided past the portioning chamber, in the case of a dismantled portioning rotor. Alternatively or additionally, an adapter can be insertable into the granular material portioning device. The portion application mode can be set by inserting the adapter. As a result of the insertion of the adapter, the band application mode can alternatively be set. As an alternative to the insertion of the adapter, it is possible to switch over to the portion application mode from the band application mode. Furthermore, by inserting the adapter it is possible to switch from the portion application mode to the band application mode. The flow path of the granular material flow within the granular material portioning device can be changed by the adapter. Furthermore, the operation of the portioning rotor can be influenced by the adapter.

A cover of the granular material portioning device can also be mountable in different orientations, the portion application mode being set by mounting the cover in a first orientation, and the band application mode is set by mounting the cover in a second orientation. For example, the cover can be mounted having the inner side facing outwards, as a result of which the inlet and the outlet of the granular material portioning device are directly connected to one another, so that no portion formation takes place.

Alternatively or additionally, the rotor of the granular material portioning device can be mountable in different orientations, wherein the portion application mode is set by mounting the rotor in a first orientation, and the band application mode is set by mounting the cover in a second orientation. For example, the rotor can be mounted in the reverse orientation, as a result of which no portions of granular material are formed, such that a band application takes place.

Furthermore, the entire granular material portioning device can be removed and replaced by an adapter, in order to switch from the portion application mode to the band application mode. Alternatively, the granular material portioning device can be bridged by means of an adapter, so that the granular material flow does not flow through the granular material portioning device.

In a development of the application unit according to the invention, a portioning rotor and a band application rotor are inserted into the portioning region of the granular material portioning device, in the portion application mode, and a band application rotor is used in the band application mode. The portioning rotor and the band application rotor can be rotatably driven by means of a rotor drive of the granular material portioning device. The portioning rotor is designed to combine granular material grains, located in the portioning region, to form a portion of granular material, by means of a rotational movement. The band application rotor is designed to convey granular material grains located in the portioning region out of the portioning region and/or to convey them through the portioning region, by means of a rotational movement, without portion formation. The portioning rotor can have, for example, one or more portioning blades which, during a rotational movement, collect granular material grains located in the portioning region. The band application rotor can have a plurality of drivers or a revolving brush or a revolving brush ring, the plurality of drivers and the brush or the brush ring not combining the granular material grains, located in the portioning region, despite a rotational movement of the band application rotor.

In a preferred embodiment, the application unit according to the invention has a granular material guide system, by means of which a granular material flow conveying bulk granular material can be introduced into a portioning region of the granular material portioning device, and by means of which portions of granular material created by the granular material portioning device can be guided in the direction of the agriculturally used area. The granular material guide system therefore preferably has one or more granular material lines or channels which are located upstream of the granular material portioning device, in the flow direction of the granular material. Furthermore, the granular material guide system preferably has one or more granular material lines or channels which are located downstream of the granular material portioning device, in the flow direction of the granular material. The granular material guide system preferably comprises a feed line via which a granular material flow can be fed to the granular material portioning device. Preferably, the granular material guide system has an ejection channel, via which created portions of granular material are guided in the direction of the agriculturally used area. The air separator can be a component of the granular material guide system.

The application unit according to the invention is further advantageously developed in that the granular material guide system is designed to introduce the granular material flow, in the band application mode and/or the portion application mode, into the granular material portioning device, in particular into the portioning region of the granular material portioning device. When the granular material flow is introduced into the granular material portioning device, in the band application mode, no portion formation takes place in the granular material portioning device. When the granular material flow is introduced into the granular material portioning device, in the portion application mode, portion formation takes place in the granular material portioning device.

In another embodiment of the application unit according to the invention, the granular material guide system has a bypass line, by means of which the granular material flow can be conducted past the granular material portioning device, so that no introduction of the granular material flow into the granular material portioning device takes place. Alternatively or additionally, the granular material portioning device can have a bypass line, by means of which the granular material flow can be conducted past the portioning region of the granular material portioning device, so that no introduction of the granular material flow into the portioning region of the granular material portioning device takes place.

In an advantageous embodiment of the application unit according to the invention, the bypass line is connected to a switching device via which the granular material flow can be selectively conducted through the granular material portioning device or through the bypass line. The switching device can be a flow divertor comprising a switching flap. The switching device can be equipped with end position sensors for the flap. The switching device can be arranged in or behind a Y-piece comprising an inlet channel and two outlet channels, it being possible for the outlet channels to be individually blockable. The switching device can, for example, be a component of the air separator or be arranged in the air separator.

In a further preferred embodiment of the application unit according to the invention, the switching device is manually adjustable and/or has a controllable actuator, by means of which the switching device is adjustable. By the manual adjustment of the switching device, it is possible for the operator to manually determine whether the granular material flow is to flow through the granular material portioning device or through the bypass line. The switching device can comprise one or more actuatable switching elements.

An agricultural application machine preferably has a plurality of application units arranged next to one another, the individual application units each being assigned to a row, along which the granular material is to be applied onto the agriculturally used area. The application units of an application machine can be controlled separately from one another, so that portioned application of the granular material takes place in one or more rows, and at the same time a band application of the granular material takes place in one or more rows. In this way, the portioned application of the granular material can be interrupted locally and temporarily, and replaced by the conventional band application. Preferably, the air separators of the respective application units or their separation behavior can also be controlled independently of one another.

The object on which the invention is based is further achieved by a method of the type mentioned at the outset, within the scope of the method according to the invention air being separated from the granular material flow by means of an air separator of the application unit. The granular material is preferably applied onto the agriculturally used area by means of an application unit according to any of the embodiments described above. With regard to the advantages and modifications of the method according to the invention, reference is thus first made to the advantages and modifications of the application unit according to the invention.

Preferably, the method comprises adjusting the separation behavior of the air separator, in particular depending on the set application mode of the application unit.

The method according to the invention can further comprise operating the application unit in a portion application mode in which the granular material is applied onto the agriculturally used area discontinuously, in the form of portions of granular material. In addition, the method can comprise operating the application unit in a band application mode, in which the granular material is applied onto the agriculturally used area continuously, in the form of a granular material band.

Preferred embodiments of the invention are explained and described in more detail below with reference to the accompanying drawings, in which:

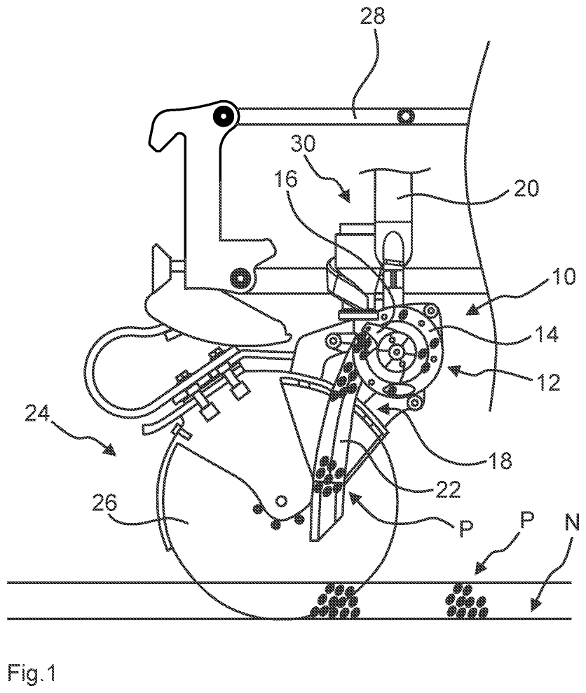

FIG. 1 shows an embodiment of the application unit according to the invention, which is operated in a portion application mode;

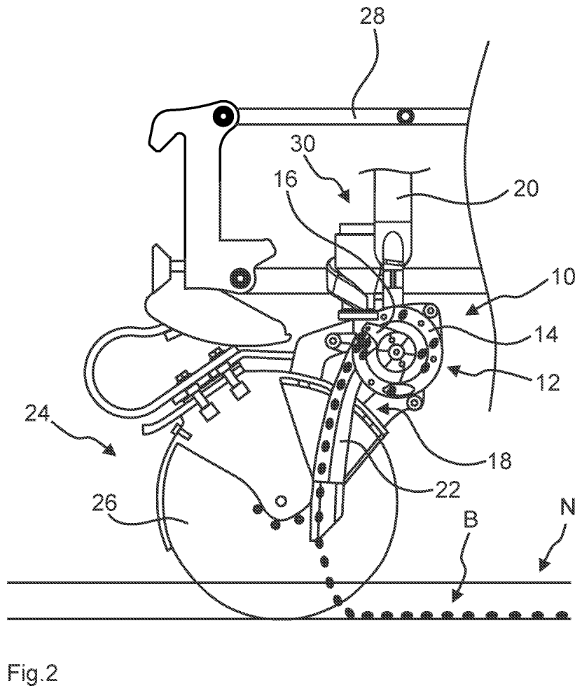

FIG. 2 shows the application unit depicted in FIG. 1, while it is operated in a band application mode;

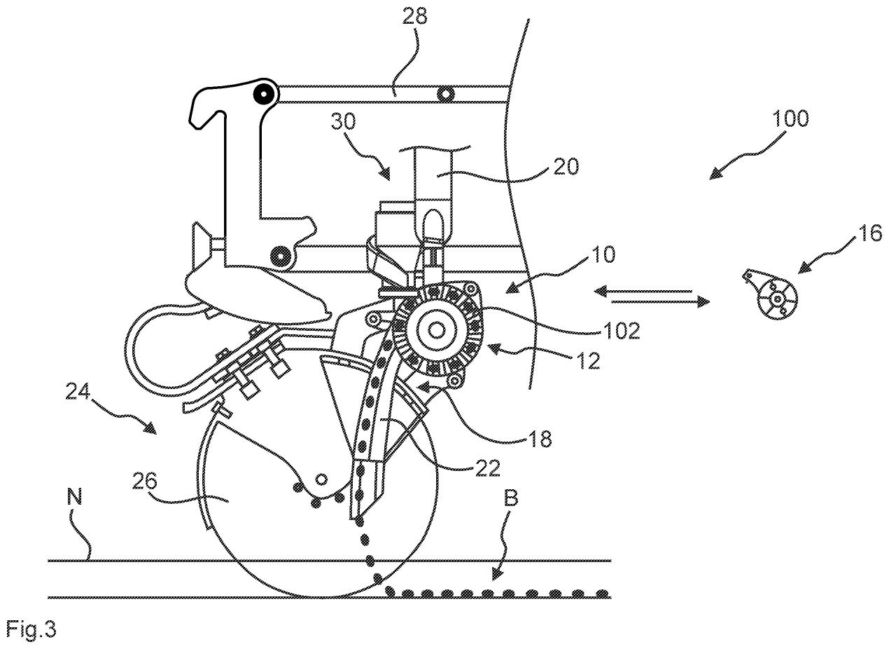

FIG. 3 shows a system consisting of an application unit and a band application rotor, as well as a portioning rotor;

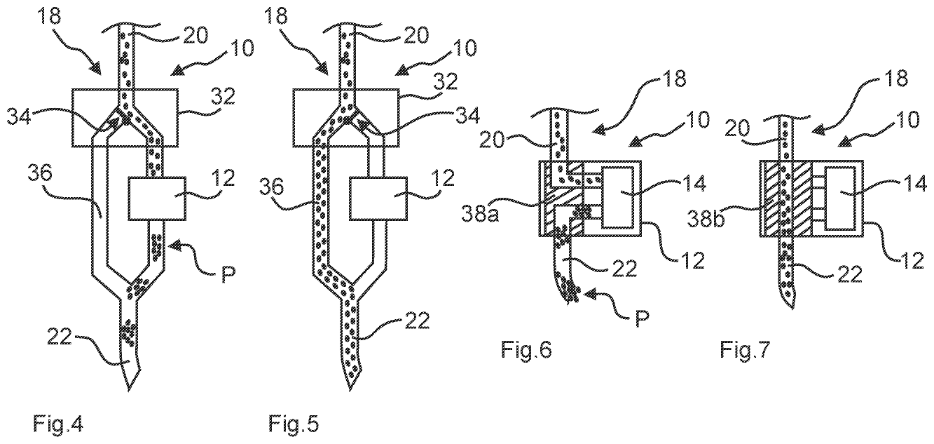

FIG. 4 shows a further embodiment of the application unit according to the invention, which is operated in a portion application mode;

FIG. 5 shows the application unit depicted in FIG. 4, while it is operated in a band application mode;

FIG. 6 shows a further embodiment of the application unit according to the invention, which is operated in a portion application mode;

FIG. 7 shows the application unit depicted in FIG. 6, while it is operated in a band application mode;

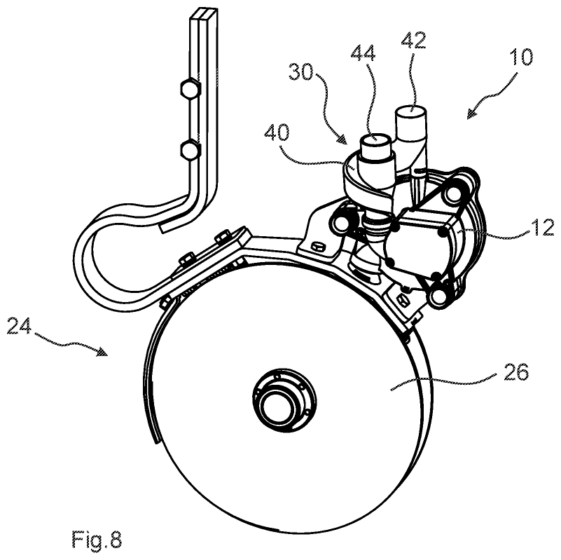

FIG. 8 shows a further embodiment of the application unit according to the invention comprising an air separator;

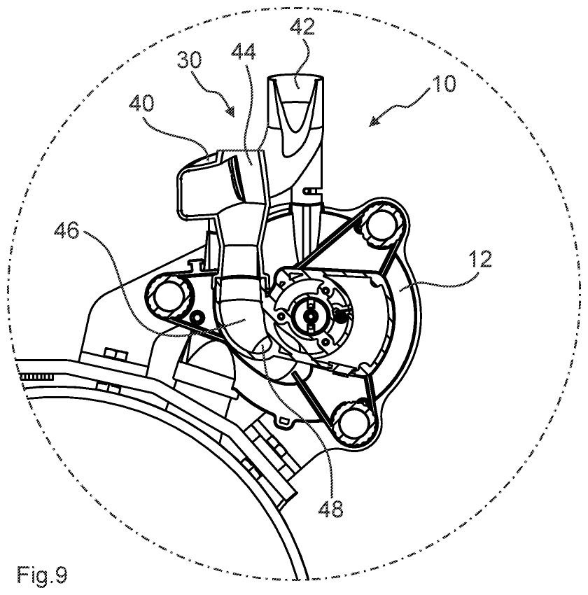

FIG. 9 shows a sectional view of the application unit shown in FIG. 8;

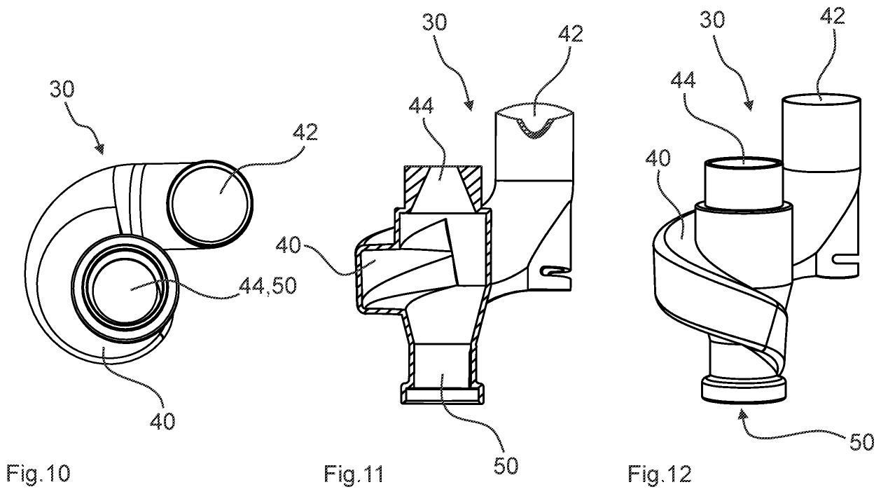

FIG. 10 shows a plan view of the application unit shown in FIG. 8;

FIG. 11 shows a sectional view of the air separator shown in FIG. 10; and

FIG. 12 shows a side view of the air separator shown in FIG. 10.

FIGS. 1 and 2 show an application unit 10 for an agricultural application machine, by means of which granular material, namely fertilizer, can be applied onto an agriculturally used area N.

The application unit 10 further comprises a granular material portioning device 12, by means of which portions P of granular material can be created. For this purpose, the granular material portioning device 12 has a portioning region 14 in which a portioning rotor 16 is arranged. The portioning rotor 16 is rotationally driven by means of a rotor drive of the granular material portioning device 12.

The application unit 10 can be operated in a portion application mode and in a band application mode. In the portion application mode, the granular material is applied onto the agriculturally used area N discontinuously, in the form of portions P of granular material created by the granular material portioning device 12. In the band application mode, the granular material is applied onto the agriculturally used area N continuously, in the form of a granular material band B.

FIG. 1 shows the application unit 10 while it is operated in the portion application mode. In the portion application mode, the granular material grains located in the portioning region 14 are combined to a portion P of granular material, by the portioning rotor 16, by means of a rotational movement of the portioning rotor 16.

The granular material grains pass via the granular material guide system 18 into the granular material portioning device 12, and are also guided through the granular material guide system 18 in the direction of the agriculturally used area N. The granular material guide system 18 has a feed line 20 via which the granular material flow is fed to an air separator 30, the granular material flow passing into the granular material portioning device 12 after passing through the air separator 30. Furthermore, the granular material guide system 18 has an ejection channel 22, by means of which the portions P of granular material created are into ejected the granular material application groove.

The granular material application groove is created by the blade 24, the blade 24 being a double-disc blade comprising two discs 26. The application unit 10 can be fixed to a crossbeam of the agricultural application machine via the holder 28.

FIG. 2 shows the application unit 10 while it is operated in the band application mode. A control device of the application unit 10 controls the rotor drive of the portioning rotor 16, in the band application mode, in such a way that the portioning rotor 16 has a rotational speed which corresponds to the flow rate of the granular material flow. Since the rotational speed of the portioning rotor 16 matches the flow rate of the granular material flow, the granular material grains located in the portioning region 14 are not combined to form a portion P of granular material. The continuous granular material flow is thus conducted through the granular material portioning device 12 without portion formation. The flow rate of the granular material flow is adjusted via the air separator 30.

Air can be separated from the granular material flow by means of the air separator 30, the separation behavior of the air separator 30 being adjustable. If a granular material flow conveying bulk granular material is to be passed through the granular material portioning device 12, a pneumatic conveying of the granular material through the granular material portioning device 12 can be achieved by setting a suitable separation behavior at the air separator 30. Furthermore, the flow rate of the granular material flow can be adjusted via the amount or the proportion of the separated air so that said flow corresponds to the rotational speed of the portioning rotor 16.

The air separator 30 can be operated in a separation mode and in a through-flow mode. In the separation mode, air is separated from the granular material flow. In the through-flow mode, no air or at least a smaller amount of air is separated from the granular material flow than in the separation mode. In the operating state shown in FIG. 1, the air separator 30 is operated in the separation mode. In the operating state shown in FIG. 2, the air separator 30 is operated in the through-flow mode.

FIG. 3 shows a system 100 consisting of an application unit 10, from which the portioning rotor 16 has been removed and replaced by a band application rotor 102. For example, the granular material portioning device 12 can have a housing having a removable cover, the portioning rotor 16 being removable and being replaceable by a band application rotor 102, when the cover is removed. If the application unit 10 is to be operated in the portion application mode, the portioning rotor 16 is thus to be inserted into the granular material portioning device 12. If the application unit 10 is to be operated in the band application mode, the band application rotor 102 is thus to be inserted into the granular material portioning device 12.

Both rotors 16, 102 are rotationally driven by means of the rotor drive of the granular material portioning device 12. The portioning rotor 16 is designed to combine granular material grains, located in the portioning region 14, to form a portion P of granular material, by means of a rotational movement. The band application rotor 102 is designed to convey granular material grains located in the portioning region 14 out of the portioning region 14, and thus conduct them through the portioning region 14, by means of a rotational movement, without portion formation. For this purpose, the band application rotor 102 has a revolving brush ring which can receive the granular material grains in the region of an inlet opening of the portioning region 14, and release them again in the region of an outlet opening of the portioning region 14, without portion formation taking place within the portioning region 14.

As an alternative to a set consisting of a plurality of rotors 16, 102, one portioning rotor 16 can also be used, which can be modified in order to operate the application unit 10 in the band application mode. Furthermore, the granular material portioning device 12 can be designed to be operated, in the band application mode, without a portioning rotor 16, so that no rotor is located in the portioning region 14 in the band application mode. For this purpose, the portioning rotor 16 is to be dismantled or removed from the granular material portioning device 12, for switching to the band application mode. In this case, the inlet opening of the portioning region 14 can be directly connected to the outlet opening of the portioning region 14, so that the granular material flow is conducted through the portioning region 14 without portion formation.

FIGS. 4 and 5 show an application unit 10, the granular material guide system 18 of which has a bypass line 36. By means of the bypass line 36, the granular material flow can be conducted past the granular material portioning device 12 so that no introduction of the granular material flow into the granular material portioning device 12 takes place. For this purpose, the application unit has a switching device 32, via which the granular material flow can be selectively conducted through the granular material portioning device 12 or through the bypass line 36. The switching device 32 is a flow divertor comprising a switching flap 34. The switching flap 34 is arranged in a Y-piece, having an inlet channel and two outlet channels. The switching device 32 can be manually adjustable and/or have a controllable actuator, by means of which the switching device 32 can be adjusted.

In the state shown in FIG. 4, the switching device 32 guides the granular material flow into the granular material portioning device 12, so that portion formation takes place. In the state shown in FIG. 5, the line leading to the granular material portioning device 12 is blocked by the switching flap 34, so that the granular material flow is introduced into the bypass line 36. By introducing the granular material flow into the bypass line 36, the granular material flow is conducted past the granular material portioning device 12 so that no granular material portioning takes place.

FIGS. 6 and 7 show an application unit 10 in which different adapters 38a, 38b can be inserted into the granular material portioning device 12. The adapter 38a influences the granular material flow within the granular material portioning device 12 such that the granular material flow is fed to the portioning region 14, so that portion formation takes place within the portioning region 14. The adapter 38b has a flow line which guides the granular material flow past the portioning region 14, so that no portion formation takes place.

In another embodiment, only one adapter is required in order to be able to operate the application unit 10 in the band application mode and in the portion application mode. In this case, the adapter is, for example, a blocking adapter or a release adapter, which blocks or releases a flow line to the portioning region 14 of the granular material portioning device 12.

FIGS. 8 and 9 show an application unit 10 in which an air separator 30 is placed or attached directly onto the granular material portioning device 12. In this case, air can be separated from the granular material flow, by means of the air separator 30, before the granular material portioning device 12, i.e., before it is introduced into the granular material portioning device 12. The air separator 30 is a centrifugal separator or a cyclone.

FIGS. 10 to 12 show that the air separator 30 has a coil 40, via which the centrifugal separation is realized. The granular material flow is introduced into the housing of the air separator 30 via the inlet opening 42. The air separated from the granular material flow can leave the air separator 30 via the air outlet 44. In the embodiment shown, the separated air is discharged into the surroundings via the air outlet 44. The separation behavior of the air separator 30 can be adjustable manually or via an actuator. For example, the air separator 30 can have a movable separation adjusting member, via the position and/or orientation of which the separation behavior of the air separator can be adjusted. By means of the separation adjusting member, for example the air outlet 44 can be blocked in part or completely, so that the amount or the proportion of the separated air can be adjusted via the degree of blocking of the air outlet 44.

The air separator 30 has an outlet opening 50, via which the granular material flow can leave the air separator 30. The outlet opening 50 of the air separator 30 can be connected directly to the inlet 46 of the granular material portioning device 12. In the state shown in FIG. 9, the portioning rotor 16 of the granular material portioning device 12 is positioned such that the inlet 46 is directly connected to the outlet 48 of the granular material portioning device 12. In the band application mode, the portioning rotor 16 can be stationary, for example, so that the granular material flow is conducted through the granular material portioning device 12 without portion formation.

### LIST OF REFERENCE SIGNS

10 Application unit
12 Granular material portioning device
14 Portioning region
16 Portioning rotor
18 Granular material guide system
20 Feed line
22 Ejection channel
24 Blade
26 Discs
28 Holder
30 Air separator
32 Switching device
34 Switching flap
36 Bypass line
38a, 38b Adapter
40 Coil
42 Inlet opening
44 Air outlet
46 Inlet
48 Outlet
50 Outlet opening
100 System
102 Band application rotor
B Granular material band
N Used area
P Portions of granular material

1. Application unit (10) for an agricultural application machine for applying granular material to an agriculturally used area (N), comprising
a granular material portioning device (12) into which a granular material flow conveying bulk granular material can be introduced and by means of which portions (P) of granular material can be created from the granular material flow;
characterized by an air separator (30) that allows air to be separated from the granular material flow.

2. Application unit (10) according to claim 1,
characterized in that the air separator (30) is arranged upstream of the granular material portioning device (12) in the flow direction of the granular material flow.

3. Application unit (10) according to claim 1,
characterized in that the air separator (30) is a component of the granular material portioning device (12).

4. Application unit (10) according to any of the preceding claims,
characterized in that the separation behavior of the air separator (30) is adjustable.

5. Application unit (10) according to any of the preceding claims,
characterized in that the air separator (30) can be operated in a separation mode in which air is separated from the granular material flow, and a through-flow mode in which no air or at least a smaller amount of air than in the separation mode is separated from the granular material flow.

6. Application unit (10) according to either claim 4 or claim 5,
characterized in that the separation behavior of the air separator (30) is manually adjustable, and/or the air separator (30) can be manually switched between the separation mode and the through-flow mode.

7. Application unit (10) according to any of claims 4 to 6,
characterized in that the air separator (30) has a controllable actuator, by means of which the separation behavior of the air separator (30) can be adjusted and/or by means of which the air separator (30) can be switched between the separation mode and the through-flow mode.

8. Application unit (10) according to any of the preceding claims,
characterized in that the application unit (10) can be operated in a portion application mode, in which the granular material is applied to the agriculturally used area (N) discontinuously in the form of portions (P) of granular material created by the granular material portioning device (12), and in a band application mode, in which the granular material is applied continuously in the form of a granular material band (B) onto the agriculturally used area (N).

9. Application unit (10) according to claim 8,
characterized in that the granular material portioning device (12) has a portioning rotor (16) which is arranged in a portioning region (14) and can be rotatably driven by means of a rotor drive of the granular material portioning device (12) and is designed to combine granular material grains located in the portioning region (14), in the portion application mode, by means of a rotational movement, in order to form a portion (P) of granular material, a control device of the application unit (10) preferably being designed to control the rotor drive of the portioning rotor (16) in the band application mode in such a way that the portioning rotor (16) has a rotational speed which corresponds to the flow rate of the granular material flow, so that the granular material grains present in the portioning region (14) are not combined to form a portion (P) of granular material.

10. Application unit (10) according to claim 9,
characterized in that the granular material portioning device (12) is designed to be operated in the band application mode without a portioning rotor (16) or with a portioning rotor (16) that is modified in comparison to the portion application mode.

11. Application unit (10) according to any of claims 8 to 10,
characterized in that a portioning rotor (16) is inserted into a portioning region (14) of the granular material portioning device (12) in the portion application mode, and a band application rotor (102) is inserted in the band application mode, wherein the portioning rotor (16) and the band application rotor (102) are able to be rotatably driven by means of a rotor drive of the granular material portioning device (12), and the portioning rotor (16) is designed to combine granular material grains located in the portioning region (14), by a rotational movement, to form a portion (P) of granular material, and the band application rotor (102) is designed to convey granular material grains located in the portioning region (14) out of the portioning region (14) and/or convey these through the portioning region (14), by means of a rotational movement, without portion formation.

12. Application unit (10) according to any of claims 8 to 11,
characterized by a granular material guide system (18) which is designed to introduce the granular material flow, in the band application mode and/or the portion application mode, into the granular material portioning device (12), in particular into a portioning region (14) of the granular material portioning device (12), the granular material guide system (18) preferably having a bypass line (36), by means of which the granular material flow can be conducted past the granular material portioning device (12), so that no introduction of the granular material flow into the granular material portioning device (12) takes place.

13. Application unit (10) according to claim 12,
characterized in that the bypass line (36) is connected to a switching device (32), via which the granular material flow can be selectively conducted through the granular material portioning device (12) or through the bypass line (36).

14. Method for applying granular material onto an agriculturally used area (N) by means of an application unit (10) of an agricultural application machine, in particular by means of an application unit (10) according to any of the preceding claims, comprising the steps of:
introducing a granular material flow, conveying bulk granular material, into a granular material portioning device (12); and
creating portions (P) of granular material by means of the granular material portioning device (12) from the granular material flow introduced into the granular material portioning device (12);
characterized by the step of:
separating air from the granular material flow by means of an air separator (30) of the application unit (10).
